(19) United States
(12) Patent Application Publication
(10) Pub. No.: US 2025/0382176 A1
(43) Pub. Date: Dec. 18, 2025

(54) METHOD FOR PRODUCING HIGH-PURITY PHOSPHORIC ACID THROUGH QUANTUM BEHAVIOR CONTROL

(71) Applicant: RAM TECHNOLOGY CO., LTD., Yongin-si (KR)

(72) Inventors: June Ing KIL, Seoul (KR); Jeong Jun PARK, Seoul (KR); Young Su JANG, Hwaseong-si (KR); Min Kyu CHOI, Yongin-si (KR); Ji Hyeon PARK, Yongin-si (KR); Ji Hoon HEO, Paju-si (KR)

(73) Assignee: RAM TECHNOLOGY CO., LTD., Yongin-si (KR)

(21) Appl. No.: 19/235,887

(22) Filed: Jun. 12, 2025

(30) Foreign Application Priority Data
Jun. 12, 2024 (KR) 10-2024-0076621

(51) Int. Cl. C01B 25/238

(52) U.S. Cl. CPC C01B 25/238; C01P 2006/80

(57) ABSTRACT

The present disclosure relates to a method for producing high-purity phosphoric acid through a quantum behavior control, and more particularly, to a method for producing high-purity phosphoric acid capable of obtaining high-purity phosphoric acid from low-grade phosphoric acid economically and industrially by obtaining phosphoric acid crystals by, using a temperature difference between inner and outer jackets of a cooling device, controlling crystal growth position and rate of the phosphoric acid crystals through changes in the molecular or quantum behaviors of impurities in phosphoric acid, thereby suppressing a phenomenon of impurities being trapped inside the phosphoric acid crystals.

### TECHNICAL FIELD

The present disclosure relates to a method for producing high-purity phosphoric acid through a quantum behavior control, and more particularly, to a method for producing high-purity phosphoric acid capable of obtaining high-purity phosphoric acid from low-grade phosphoric acid economically and industrially by obtaining phosphoric acid crystals by, using a temperature difference between inner and outer jackets of a cooling device, controlling crystal growth position and rate of the phosphoric acid crystals through changes in the molecular or quantum behaviors of phosphoric acid, water molecules and impurities in a phosphoric acid raw material, thereby suppressing a phenomenon of impurities being trapped inside the phosphoric acid crystals.

### BACKGROUND ART

Phosphoric acid is an essential chemical material in a semiconductor manufacturing process as an only substance capable of wet-etching a semiconductor silicon nitride film (Si₃N₄, SiN). In such a silicon nitride film etching process, impurities in the phosphoric acid etchant directly affect semiconductor yield and defect occurrences, and therefore, the concentration is strictly controlled.

Since high-purity phosphoric acid usable in such a semiconductor manufacturing process may only be produced through a dry method of extracting yellow phosphorous (P4) from high-quality phosphorite and oxidizing and burning the yellow phosphorous at a high temperature of 200° C. or higher, a lot of process cost is required.

In addition, due to the limited reserves of high-quality phosphorite, depletion of the mineral is accelerated, and this causes a problem of continuously increasing the price of high-purity phosphoric acid, leading to an economical problem of increasing a semiconductor manufacturing cost.

As an existing method for purifying phosphoric acid containing a large amount of metal ion impurities, various methods such as a film separation method, an ion exchange method or a liquid extraction method have been proposed.

First, the film separation method has advantages of high yield and purity of collected phosphoric acid, but has disadvantages of high film separation process cost and very complicated operation method. In addition, there may be a safety issue for the used film due to the corrosiveness of phosphoric acid.

The ion exchange method uses an ion exchange resin or calcium zeolite to remove an acid, and since the ion exchange resin used herein has low ion exchange capacity, only an acid with low concentration may be treated, and since the ion exchange resin after completing ion exchange needs to be continuously replaced, there is a limit of incurring continuous process cost.

The liquid extraction method has advantages in that the process may be continuously operated and the devices are inexpensive, but has a disadvantage in that high-purity phosphoric acid at a level required for a semiconductor process is not able to be obtained.

A crystallization method is a method of forming crystals from a saturated solution by controlling nucleation and crystal growth rates of crystals.

The crystallization method may be divided into a method of crystallization using a phosphoric acid seed for facilitating nucleation of crystals, and a method of crystallization not using a phosphoric acid seed. When a phosphoric acid seed is not used, the crystallization condition needs to be controlled to a temperature of 40° C. below zero or lower to proceed with crystallization, causing a problem of requiring a lot of cost and time to form crystals.

Accordingly, there is a demand for the development of a new method for producing phosphoric acid capable of obtaining high-purity phosphoric acid that does not include unnecessary metals economically and industrially by separating impurities from a phosphoric acid raw material containing a lot of impurities.

### DISCLOSURE

### Technical Problem

The present disclosure is directed to providing a method for producing high-purity phosphoric acid through a quantum behavior control capable of obtaining phosphoric acid economically and industrially.

The present disclosure relates to a method for producing high-purity phosphoric acid capable of obtaining high-purity phosphoric acid from low-grade phosphoric acid economically and industrially by, using a temperature difference between inner and outer jackets of a cooling device, obtaining phosphoric acid crystals through controlling crystal growth position and rate of the phosphoric acid crystals through changes in the molecular or quantum behaviors of phosphoric acid, water molecules and impurities in a phosphoric acid raw material, thereby suppressing a phenomenon of impurities being trapped inside the phosphoric acid crystals.

### Technical Solution

One embodiment of the present disclosure provides a method for manufacturing high-purity phosphoric acid, the method including the steps of: supplying a phosphoric acid raw material containing impurities to a cooling device including an inner jacket and an outer jacket (S1); and forming phosphoric acid crystals by introducing a phosphoric acid seed to the cooling device (S2), wherein the inner jacket and the outer jacket have a temperature difference of 5° C. or greater.

The inner jacket and the outer jacket may have a temperature difference of 40° C. or less.

A temperature of the inner jacket may be from 0° C. to 30° C.

A temperature of the outer jacket may be from 5° C. to 50° C.

The phosphoric acid raw material may have a concentration of 85% to 91.6%.

The method for producing high-purity phosphoric acid of the present disclosure may further include, after the step of forming phosphoric acid crystals (S2), partially melting some of the crystallized phosphoric acid by raising the temperature of the inner jacket to 30° C. to 35° C. (S3).

The method for producing high-purity phosphoric acid of the present disclosure may further include, after separating the partially melted phosphoric acid, obtaining phosphoric acid crystals not melted in the partially melting step (S3) by raising the temperature of the inner jacket to 40° C. or higher (S4).

In the phosphoric acid raw material, a total content of the impurities including Al, K and Cu may be 300 ppb or greater.

The phosphoric acid obtained using the above-described method may include Al, K and Cu each in an amount of 1 ppb or less.

### Advantageous Effects

High-purity phosphoric acid may be produced economically and industrially when using a method for producing high-purity phosphoric acid through a quantum behavior control provided in the present disclosure.

### BEST MODE

Unless defined otherwise in the present specification, all technical terms and scientific terms have the same meaning as meanings commonly understood by those skilled in the art. Terms used for the description in the present disclosure are only to effectively describe specific embodiments and are not intended to limit the present disclosure.

Singular forms used in the present specification include plural forms as well, unless the context clearly indicates otherwise.

The term ‘include’ used in the present specification specifies specific features, areas, integers, steps, operations, elements and/or components, and does not exclude the presence or addition of other specific features, areas, integers, steps, operations, elements, components and/or groups.

The present disclosure may have various modifications applied thereto, and may have various forms, and specific embodiments will be illustrated and described in detail below. However, this is not intended to limit the present disclosure to specific disclosed forms, and needs to be construed as including all modifications, equivalents and substitutes included in the idea and the technical scope.

In the present specification, when a positional relationship between two parts is described as, for example, ‘˜on’, ‘˜in an upper portion of’, ‘˜in a lower portion of’, ‘˜next to’ and the like, one or more other parts may be located between the two parts unless an expression such as ‘right’ or ‘directly’ is used.

In the present specification, when a temporal relationship is described as, for example, ‘˜after’, ‘˜subsequent to’, ‘˜then’, ‘˜prior to’ and the like, cases that where operations are not continuous may also be included unless an expression such as ‘immediately’ or ‘directly’ is used.

In the present specification, the term ‘at least one’ needs to be construed as including all combinations presentable from one or more related items.

Hereinafter, a method for producing high-purity phosphoric acid according to specific embodiments of the present disclosure will be described in more detail.

According to one embodiment of the present disclosure, there is provided a method for producing high-purity phosphoric acid, the method including the steps of: supplying a phosphoric acid raw material containing impurities to a cooling device including an inner jacket and an outer jacket (S1); and forming phosphoric acid crystals by introducing a phosphoric acid seed to the cooling device (S2), wherein the inner jacket and the outer jacket have a temperature difference of 5° C. or greater.

As described above, a method of crystallization through cooling is well known in the related art as a method for purifying phosphoric acid, however, when a phosphoric acid seed is not used, the crystallization condition needs to be controlled to a temperature of 40° C. below zero or lower to proceed with crystallization, causing a problem of requiring a lot of cost and time to form crystals.

Accordingly, the inventors of the present disclosure have studied a method for further increasing purification efficiency while performing crystallization at room temperature using a phosphoric acid seed, and as a result, have identified that, when using a cooling device including an inner jacket and an outer jacket and controlling a temperature difference between the inner jacket and the outer jacket to a certain level, high-purity phosphoric acid may be obtained on an economical and industrial scale by improving purification efficiency using a method of suppressing a phenomenon of impurities being trapped inside phosphoric acid crystals by controlling crystal growth position and rate of the phosphoric acid crystals through changes in the molecular or quantum behaviors of phosphoric acid, water molecules and impurities in a phosphoric acid raw material, and have completed the present disclosure.

According to the present disclosure, phosphoric acid with higher purity may be obtained by improving impurity purification efficiency when the method includes the steps of: supplying a phosphoric acid raw material containing impurities to a cooling device including an inner jacket and an outer jacket (S1); and forming phosphoric acid crystals by introducing a phosphoric acid seed to the cooling device (S2), and a temperature difference between the inner jacket and the outer jacket is controlled to 5° C. or greater.

First, as the phosphoric acid raw material, commercially available low-purity (industrial-grade) phosphoric acid may be purchased and used, or phosphoric acid used in a semiconductor cleaning process may be collected and used. However, in terms of resource recycling, it is preferred to collect and use impurity-containing phosphoric acid used in a semiconductor process.

In the method for producing high-purity phosphoric acid of the present disclosure, a phosphoric acid raw material including a large amount of impurities is supplied to a cooling device including an inner jacket and an outer jacket, and then phosphoric acid crystals are formed by introducing a phosphoric acid seed to the cooling device, and herein, a temperature difference between the inner jacket and the outer jacket may be controlled to be 5° C. or greater to increase impurity purification efficiency.

Specifically, by providing a temperature difference between the inner jacket and the outer jacket of the cooling device, changes in the molecular and quantum behaviors of phosphoric acid, water molecules and impurities in the phosphoric acid raw material prevent the crystals from being sporadically formed, and by inducing crystal growth to begin from the surface of the inner jacket, a trap phenomenon of metal impurities being trapped inside the phosphoric acid crystals may be prevented, improving metal impurity purification efficiency.

When there is no or insignificant temperature difference between the inner jacket and the outer jacket during the formation of phosphoric acid crystals by introducing a phosphoric acid seed, phosphoric acid crystallization occurs sporadically, and a large amount of impurities are included in the formed phosphoric acid crystals due to the trap phenomenon of impurities being trapped inside the phosphoric acid crystals, reducing purity of the phosphoric acid obtained from crystallization.

In comparison, when a temperature difference between the inner jacket and the outer jacket is controlled to a certain level or higher and crystallization is performed by introducing a phosphoric acid seed, a difference in the phosphoric acid crystal growth rate occurs between the inside and the outside through changes in the molecular and quantum behaviors of phosphoric acid, water molecules and impurities in the phosphoric acid raw material, preventing phosphoric acid crystals from being sporadically formed, and by inducing the phosphoric acid crystal growth to begin from the inner jacket surface, crystallization proceeds so that impurities gather towards the outer jacket. As a result, purification efficiency increases, and high-purity phosphoric acid may be obtained.

The cooling device includes an inner jacket, an outer jacket formed spaced apart on the outer side of the inner jacket, and a reaction unit having a certain space between the inner jacket and the outer jacket and to which a phosphoric acid raw material, a phosphoric acid seed and the like are introduced to proceed with crystallization of phosphoric acid.

In other words, when a phosphoric acid raw material and a phosphoric acid seed are introduced to the reaction unit, which is a space between the inner jacket and the outer jacket, phosphoric acid crystals are formed and grow in the form of wrapping the inner jacket along the surface of the inner jacket due to the temperature difference between the inner jacket and the outer jacket.

Herein, the temperature difference between the inner jacket and the outer jacket may be 5° C. or greater, and preferably 10° C. or greater. When the inner jacket and the outer jacket have a temperature difference of less than 5° C., phosphoric acid crystals are formed sporadically, causing a problem of reducing the purification effect due to a trapping phenomenon of metal impurities being trapped inside the phosphoric acid crystals.

In addition, the temperature difference between the inner jacket and the outer jacket may be 40° C. or less. When the inner jacket and the outer jacket have a temperature difference of greater than 40° C., there may be a problem in that phosphoric acid crystals do not grow sufficiently.

Specifically, the temperature of the inner jacket may be from 0° C. to 30° C., and the temperature of the outer jacket may be from 5° C. to 50° C.

Herein, the inner jacket has a lower temperature than the outer jacket within the above-mentioned temperature range.

After supplying a phosphoric acid raw material containing impurities to the cooling device including the inner jacket and the outer jacket, a phosphoric acid seed is introduced to the cooling device to form phosphoric acid crystals, and herein, the phosphoric acid seed may be introduced in an amount of 0.01 parts by weight to 10 parts by weight based on 100 parts by weight of the phosphoric acid raw material.

When the introduced amount of the phosphoric acid seed is too small, there may be a problem in that the rate of phosphoric acid crystallization is slow or crystals do not grow, and when the introduced amount of the phosphoric acid seed is too large, phosphoric acid crystals may be formed sporadically, and therefore, it is preferred to introduce the phosphoric acid seed in the above-described amount.

The method for producing high-purity phosphoric acid of the present disclosure may further include, after the step of forming phosphoric acid crystals (S2), partially melting some of the crystallized phosphoric acid by raising the temperature of the inner jacket to 30° C. to 35° C. (S3).

The crystallized phosphoric acid having grown along the inner jacket surface by the crystallization process includes pure phosphoric acid with almost no impurities inside the crystal, and has the amount of impurities increasing towards the crystal surface.

Accordingly, by raising the temperature of the inner jacket to 30° C. to 35° C. to partially melt some of the phosphoric acid crystal surface, impurities attached to the surface may be removed, and phosphoric acid with higher purity may be obtained.

After that, the partially melted phosphoric acid is separated, and then phosphoric acid crystals not melted in the partially melting step (S3) may be obtained by raising the temperature of the inner jacket to 40° C. or higher (S4).

The phosphoric acid raw material before the purification includes a large amount of impurities, and specifically, the total content of impurities including Al, K and Cu may be 300 ppb or greater in the phosphoric acid raw material.

As described above, high-purity phosphoric acid may be obtained economically and industrially using the method for producing high-purity phosphoric acid of the present disclosure, and specifically, the phosphoric acid obtained using the method may include Al, K and Cu each in an amount of 1 ppb or less.

Hereinafter, embodiments of the present disclosure will be described in more detail with reference to the following examples. However, the following examples are just for illustrating embodiments of the present disclosure, and the present disclosure is not limited by the following examples.

### (1) Example 1

A 91.6% phosphoric acid raw material (1,000 g) including impurities was supplied to a cooling device in which a temperature of an inner jacket is set to 15° C. and a temperature of an outer jacket is set to 25° C. (temperature difference between inner jacket and outer jacket is 10° C.).

A phosphoric acid seed (1 g) was introduced to the cooling device, and phosphoric acid crystallization was performed for 1 hour.

Phosphoric acid that was not crystallized was removed, and then some of the crystallized phosphoric acid was partially melted and separated by raising the temperature of the inner jacket to 30° C.

The remaining phosphoric acid crystals (779 g) not melted were all melted by raising the temperature to 40° C. or higher, and finally purified crystallized phosphoric acid was obtained.

### (2) Example 2

Crystallized phosphoric acid (795 g) was obtained in the same manner as in Example 1, except that the temperature of the inner jacket was set to 0° C. and the temperature of the outer jacket was set to 25° C. (temperature difference between inner jacket and outer jacket is 25° C.).

### (3) Example 3

Crystallized phosphoric acid (614 g) was obtained in the same manner as in Example 2, except that the temperature of the inner jacket was set to 0° C. and the temperature of the outer jacket was set to 40° C. (temperature difference between inner jacket and outer jacket is 40° C.).

### (4) Example 4

Crystallized phosphoric acid (463 g) was obtained in the same manner as in Example 1, except that the concentration of the phosphoric acid raw material was set to 85%.

### (5) Comparative Example 1

Crystallized phosphoric acid (600 g) was obtained in the same manner as in Example 1, except that both the inner jacket and the outer jacket were set to have temperatures of 15° C. (no temperature difference between inner jacket and outer jacket).

### (6) Comparative Example 2

A 91.6% phosphoric acid raw material (1,000 g) including impurities was supplied to a cooling device in which a temperature of an inner jacket is set to 5° C. and a temperature of an outer jacket is set to 50° C. (temperature difference between inner jacket and outer jacket is 45° C.).

A phosphoric acid seed (1 g) was introduced to the cooling device, and phosphoric acid crystallization was performed for 1 hour.

Phosphoric acid that was not crystallized was removed, and an attempt was made to partially melt and separate some of the crystallized phosphoric acid by raising the temperature of the inner jacket to 30° C., however, crystallized phosphoric acid was all melted when raising the temperature to 30° C., and accordingly, the temperature was not able to be further raised (40° C. or higher).

### <Analysis on Metal Impurity Content in Crystallized Phosphoric Acid>

For each of the phosphoric acid raw material, the non-crystallized phosphoric acid, the phosphoric acid partially melted and separated, and the crystallized phosphoric acid obtained by raising the temperature to 40° C. or higher, the content of metal impurities in the phosphoric acid was analyzed using ICP-MS.

Specifically, the non-crystallized phosphoric acid, the partially melted phosphoric acid, and the crystallized phosphoric acid were each diluted with DIW or 3% nitric acid using Agilent ICP-MS 8900 to analyze the metal impurity content in the sample.

TABLE 1

| | | Example 1 | | Example 2 | | Example 3 | | Example 4 | |
|---|---|---|---|---|---|---|---|---|---|
| | | Non- | | Non- | | Non- | | Non- | |
| | | crystal- | | crystal- | | crystal- | | crystal- | |
| | | lized + | | lized + | | lized + | | lized + | |
| | | Partially | Crystal- | Partially | Crystal- | Partially | Crystal- | Partially | Crystal- |
| | | Melted | lized | Melted | lized | Melted | lized | Melted | lized |
| | Phosphoric | Phos- | Phos- | Phos- | Phos- | Phos- | Phos- | Phos- | Phos- |
| | Acid Raw | phoric | phoric | phoric | phoric | phoric | phoric | phoric | phoric |
| | Material | Acid | Acid | Acid | Acid | Acid | Acid | Acid | Acid |
| Al (ppb) | 156 | 621 | 0.5 | 601 | 0.6 | 334 | 0.7 | 265 | 0.6 |
| K (ppb) | 221 | 814 | 0.6 | 790 | 0.6 | 486 | 0.8 | 348 | 0.8 |
| Cu (ppb) | 358 | 1503 | 0.8 | 1480 | 0.9 | 813 | 0.8 | 593 | 0.8 |

TABLE 2

| | | Comparative Example 1 | | Comparative Example 2 | |
|---|---|---|---|---|---|
| | | Non- | | Non- | |
| | | crystal- | | crystal- | |
| | | lized + | | lized + | |
| | | Partially | Crystal- | Partially | Crystal- |
| | Phos- | Melted | lized | Melted | lized |
| | phoric | Phos- | Phos- | Phos- | Phos- |
| | Acid Raw | phoric | phoric | phoric | phoric |
| | Material | Acid | Acid | Acid | Acid |
| Al(ppb) | 156 | 168 | 141 | 153 | — |
| K(ppb) | 221 | 238 | 187 | 226 | — |
| Cu(ppb) | 358 | 361 | 301 | 360 | — |

From Tables 1 and 2, it was identified that the phosphoric acid obtained using the preparation method of the present disclosure had a significantly reduced metal content in the phosphoric acid compared to the phosphoric acid raw material, and thus high-purity phosphoric acid was able to be obtained.

Comparative Example 1 had a reduced metal content compared to the phosphoric acid raw material, however, the purification effect was insignificant, and in Comparative Example 2, crystallized phosphoric acid was all melted during the process of partially melting the phosphoric acid, and purification through crystallization was not achieved.

1. A method for producing high-purity phosphoric acid, the method comprising:
supplying a phosphoric acid raw material containing impurities to a cooling device including an inner jacket and an outer jacket (S1); and
forming phosphoric acid crystals by introducing a phosphoric acid seed to the cooling device (S2),
wherein the inner jacket and the outer jacket have a temperature difference of 5° C. or greater.

2. The method of claim 1, wherein the inner jacket and the outer jacket have a temperature difference of 40° C. or less.

3. The method of claim 1, wherein a temperature of the inner jacket is from 0° C. to 30° C.

4. The method of claim 1, wherein a temperature of the outer jacket is from 5° C. to 50° C.

5. The method of claim 1, further comprising, after the step of forming phosphoric acid crystals (S2), partially melting some of the crystallized phosphoric acid by raising the temperature of the inner jacket to 30° C. to 35° C. (S3).

6. The method of claim 5, further comprising the step of, after separating the partially melted phosphoric acid, obtaining phosphoric acid crystals not melted in the partially melting step (S3) by raising the temperature of the inner jacket to 40° C. or higher (S4).

7. The method of claim 1, wherein the phosphoric acid raw material has a concentration of 85% to 91.6%.

8. The method of claim 1, wherein a total content of the impurities including Al, K and Cu is 300 ppb or greater in the phosphoric acid raw material.

9. The method of claim 1, wherein the phosphoric acid obtained using the method includes Al, K and Cu each in an amount of 1 ppb or less.
